(19) United States
(12) Patent Application Publication
(10) Pub. No.: US 2026/0086975 A1
(43) Pub. Date: Mar. 26, 2026

(54) Interface Connect Disconnect Protocol

(71) Applicant: Google LLC, Mountain View, CA (US)

(72) Inventors: Sunitha R. Kosireddy, Saratoga, CA (US); Kiran Srinivasa Sastry, Santa Clara, CA (US)

(73) Assignee: Google LLC, Mountain View, CA (US)

(21) Appl. No.: 19/106,563

(22) PCT Filed: Oct. 10, 2022
(86) PCT No.: PCT/US2022/046187

§ 371 Date: Feb. 25, 2025

(51) Int. Cl. G06F 15/17; G06F 1/3287; G06F 15/177; G06F 15/78

(52) U.S. Cl. CPC G06F 15/17; G06F 15/177; G06F 15/7807; G06F 1/3287

(57) ABSTRACT

Methods, systems, and apparatus, including computer programs encoded on computer storage media, for managing an interface between a pair of processing cores of a device that are configured to exchange data. The device is configured to enable or disable one or more of the pair of processing cores. One of the methods includes configuring a connect/disconnect interface implemented as logic circuitry between the pair of processing cores to assume a connected state in which the pair of processing cores and exchange data, and configuring the connect/disconnect interface between the pair of processing cores to assume a disconnected state in which one or more of the processing cores is unable to receive data.

### BACKGROUND

Mobile computing devices, e.g., smart phones, personal digital assistants, electronic tablets, laptops, and the like, typically use power provided by one or more rechargeable batteries. A rechargeable battery provides only a finite amount of power to a device before the battery must be recharged, e.g., by applying an electric current to the battery. Recharging the battery of a mobile computing device generally requires connecting the mobile computing device to an electric grid, which reduces or eliminates its mobility.

Mobile computing devices usually including a system on a chip (SOC) which provides much of the functionality needed in the device. Because mobile computing devices are often operating from a limited supply (e.g. a battery), energy conservation is a key design consideration for the devices. Thus it is desirable to frequently power down at least some components of the SOC to eliminate leakage current losses, which are a significant factor in energy consumption in modern integrated circuit technologies.

However, a more reliable communication protocol for determination of the state of the data interfaces between different components the SOC is needed, as traffic (i.e., data transmission) between an active component and a standby component of the SOC which is unable to receive data may often result in non-recoverable data loss, which hinders device performance and user experience.

### SUMMARY

This specification describes techniques for implementing and managing a connect/disconnect interface between a pair of processing cores of a system on a chip (SOC) of a computing device. The connect/disconnect interface implements a more reliable communication protocol for a computing device that has to deal with frequent powering down of various components of the SOC.

In general, one innovative aspect of the subject matter described in this specification can be embodied a device comprising a pair of processing cores that are configured to exchange data, and wherein the device is configured to enable or disable one or more of the pair of processing cores, and wherein the device comprises logic circuitry implementing a connect/disconnect interface between the pair of processing cores, wherein the connect/disconnect interface between the pair of processing cores is configured to assume a connected state in which the pair of processing cores and exchange data, and a disconnected state in which one or more of the processing cores is unable to receive data.

Other embodiments of this aspect include corresponding methods comprising the operations performed by the device, computer systems, and computer programs recorded on one or more computer storage devices, each configured to perform the actions of the methods.

The foregoing and other embodiments can each optionally include one or more of the following features, alone or in combination. In particular, one embodiment includes all the following features in combination.

The pair of processing cores sharing the connect/disconnect interface may be controlled by respective power controllers.

When in the disconnected state, the interface may assume a disconnect-with-wakeup mode during which new traffic causes the interface to assume a connected state.

When in the disconnected state, the interface may assume a disconnect-with-terminate mode during which any traffic is terminated by one of the pair of processing cores.

Each processing core may be configured to transmit output signals to the other processing device comprising: i) send request to connect, ii) send request to disconnect, and iii) send denial of a disconnection request.

Each processing core may be configured to receive input signals from the other processing device comprising: i) receive request to connect, ii) receive request to disconnect, and iii) receive denial of a disconnection request.

The output signals and the input signals may be implemented using six separate wires between the processing cores.

Particular embodiments of the subject matter described in this specification can be implemented so as to realize one or more of the following advantages. A system on a chip (SOC) can more reliably exchange data between multiple processing cores of the SOC by making use of a connect/disconnect interface that is implemented in addition to a data interface for data transmission between the processing cores. The connect/disconnect interface allows the processing cores to initiate traffic only to other processing cores that are capable of receiving traffic, and not to any processing cores in a standby mode or other low power modes that may not have the clocks or power needed to capture the traffic that is in-flight. This approach avoids non-recoverable data loss that would otherwise occur in cases where a processing core initiates traffic to another processing core that may already be in the standby mode, or may be transitioning to/from the standby mode, and further eliminates the need to reboot the system as a result of such data loss. This approach improves the user experience of a device implementing the SOC while also reduces power consumption of the device.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of an example system.

FIG. 2 is an example illustration of a data interface and a connect/disconnect interface.

FIG. 3 is a flowchart of an example process for managing an interface between a pair of processing cores.

FIG. 4 is an illustration of an example state diagram of different states of an interface between a pair of processing cores.

Like reference numbers and designations in the various drawings indicate like elements.

### DETAILED DESCRIPTION

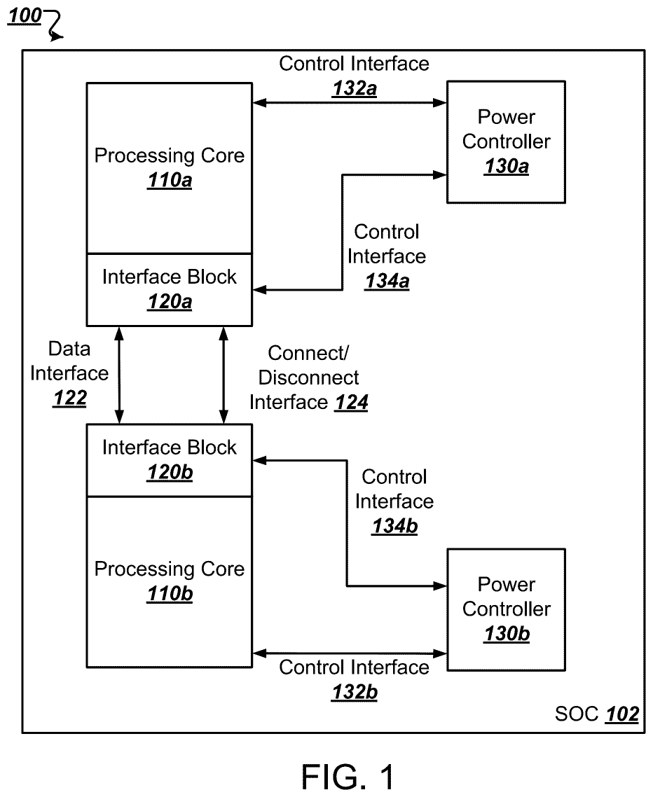

FIG. 1 is a diagram of an example system 100. The system includes a plurality of independent processing cores, e.g., processing cores 110a and 110b. The plurality of processing cores are generally capable of providing data processing capabilities, although they may be implemented in different ways and for different purposes. For example, implementations of such cores may include: 1) a general-purpose programmable processing core that includes registers, control circuitry, and an arithmetic logic unit (ALU) intended for general-purpose computing; and 2) a special-purpose processing core having specialized hardware intended primarily for graphics computing, signal processing computing, encryption computing, and so forth.

The system also includes a corresponding power controller for each of the plurality of processing cores, e.g., power controllers 130a and 130b. Each power controller may generally include logic and components needed for regulating the power states of the plurality of processing cores. In some implementations, the power controllers switch off or adjust the voltage independently to each processing core by operating independently from one another, while in other implementations, they may both be managed by a common power manager that controls which components of the system 100 receive power and how much power each component receives.

The plurality of independent processing cores and their corresponding power controllers can be integrated onto a single system on a chip (SOC) 102. The SOC 102 can be an integrated circuit that includes the aforementioned components, and possibly other components of the system, on a single silicon substrate or on multiple interconnected dies, e.g., using silicon interposers, stacked dies, or interconnect bridges.

The SOC 102 is an example of a device that can be installed on or integrated into any appropriate computing device, which may be referred to as a host device. Because the techniques described in this specification are particularly suited to reducing power consumption and increasing performance for the host device, the SOC 102 can be especially beneficial when installed on mobile host devices that rely on battery power, e.g., a smart phone, a smart watch or another wearable computing device, a tablet computer, or a laptop computer, to name just a few examples.

It is noted that the number of components of the SOC 102 may vary from implementation to implementation. For example, there may be more processing cores than the number shown in FIG. 1 that are either included in the same processor or in separate processors.

The SOC 102 includes logic circuitry that implements a respective interface block for each of the plurality of processing cores that serves as a communication interface between the plurality of processing cores 110a-b and other components in the SOC 102, including power controllers 130a-b. The power controller for each of the plurality of processing cores, e.g., power controller 130a, may be connected to the corresponding processing core, e.g., processing core 110a, as well as to the interface block for the corresponding processing core, e.g., interface block 120a. As shown in FIG. 1, the control interfaces between the power controllers and the processing cores and interface blocks, e.g., control interfaces 132a-134a and control interfaces 132b-134b, may convey control signals such as voltage control signals to the processing cores and interface blocks. A control interface protocol exchanged between the power controllers, the processing cores, and the interface blocks is used to support the handshake protocol between the interface blocks by providing the functionalities of continuously monitoring the state of the interface provided by the interface blocks 120a-b.

The interface block of each processing core, e.g., interface block 120a of processing core 110a, may be coupled to another interface block of another processing core, e.g., interface block 120b of processing core 110b, through a programmable interconnect of the SOC 102. The programmable interconnect is coupled to the multiple interface blocks to form a connection so that one or more links or channels may be formed to transmit data packets or other signals between the pair processing cores. The programmable interconnect may be, for example, asynchronous or combinatorial interconnect.

As shown in FIG. 1, the pair of interface blocks 120a-b provides an interface that includes: 1) a point-to-point data interface 122 for communications between a corresponding pair of processing cores, where either the sending and receiving of data packets occur on a pair of one-directional links, or where the sending and receiving of data packets occur on simultaneous bi-directional links; and 2) a connect/disconnect interface 124 which allows the corresponding pair of processing cores to access the state of the interface between them, i.e., a connected state or disconnected state. This connect/disconnect interface 124 allows one processing core to initiate traffic through the point-to-point data interface 122 only to another processing core that is capable of receiving traffic, by virtue of allowing the pair of processing cores to view and change whether the interface between them is in a connected state or disconnected state without any race conditions. For example, when the interface is in the connected state, a data packet initiated by processing core 110a may enter through interface block 120a, pass through the programmable interconnect, and reach the processing core 110b through interface block 120b.

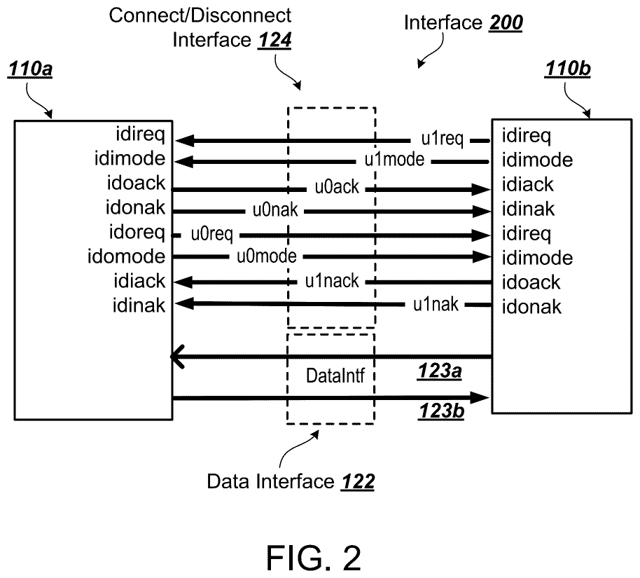

FIG. 2 is an example illustration of an interface 200 that includes a data interface 122 and a connect/disconnect interface 124 between processing cores 110a-b of FIG. 1. The data interface 122 may include a pair of point-to-point links as shown, where processing core 110a may be connected to a first link 123a for receiving data sent by processing core 110b and a second link 123b for transmitting data to processing core 110b. Put another way, link 123a and link 123b may be said to form a data interface between processing core 110a and processing core 110b. Accordingly, processing cores 110a-110b may each include a transceiver capable of transmitting and receiving data packets on corresponding links 123a-b.

In the example of FIG. 2, the connect/disconnect interface 124 is implemented as a six-wire handshake protocol with two mode bits acting in concert with the control interface protocol. The six separate wires include a request wire (u0req), an acknowledge wire (u0ack), and a negative acknowledge wire (u0nak) flowing in one direction, and a request wire (u1req), an acknowledge wire (u1ack), and a negative acknowledge wire (u1nak) flowing in the other direction.

Each processing core transmits three signals (idoreq, idoack, idonak), and receives three signals (idireq, idiack, idinak) for a total of six signals for the handshake protocol. This handshake protocol provide the ability for each processing core to: 1) send request to connect; 2) send request to disconnect; and 3) send denial a disconnection request. Likewise, this handshake protocol also provides the ability for each processing core to: 1) receive request to connect; 2) receive request to disconnect; and 3) receive denial a disconnection request.

In terms of handshake protocols, the connect/disconnect interface 124 includes two three-signal sub-handshake protocols, which coordinate with one another to achieve connection and disconnection of the interface 200. Specifically, the three signals of idoreq, idiack, and idinak are used for managing, i.e., connecting or disconnecting, the outgoing link of a processing core, and the remaining three signals of idireq, idoack, and idonak are used for managing the incoming link of the processing core.

Each processing core also transmits a 1-bit idomode signal (received at the other processing core as idimode) which indicates what mode of disconnection is being requested. For example, a low idomode signal indicates a disconnect-with-terminate mode, while a high idomode signal indicates a disconnect-with-wakeup mode.

These mode signals may not be considered a part of the handshake protocol, but used to determine the mode of operation of the handshake. Merging the incoming and outgoing mode signals enables both processing cores to reach the same disconnected state. The requirements for the mode signal are: 1) when either processing core, or both processing cores, intend to disconnect with terminate, the interface 200 must reach a disconnect-with-terminate mode; and 2) when both processing cores intend to disconnect with wakeup, the interface 200 must reach a disconnect-with-wakeup mode. The mode signals must be stable before performing connect or disconnect handshake. This eliminates any possible race conditions between two processing cores perceiving the interface 200 at different states.

In this specification, the term wakeup (or enable) will be used to mean supplying an increased amount of power to a particular processing core or other electronic circuitry. The SOC 102 may or may not have been supplying power to a processing component or other circuitry that is being awoken. In other words, a processing core being awoken may or may not have been completely powered down previously. Waking a processing core can result in the processing core performing a boot process and causing instructions and data for the processing core to be loaded into random-access memory. Alternatively or in addition, waking a processing core can include resuming from a previously suspended state. In this specification, the term terminate (or disable) will be used to mean supplying a decreased amount of power to a particular processing core or other electronic circuitry, which may not have been in an activated state previously. Terminating a processing core can result in the processing core performing a shutdown process and causing instructions and data for the processing core to be erased from the random-access memory.

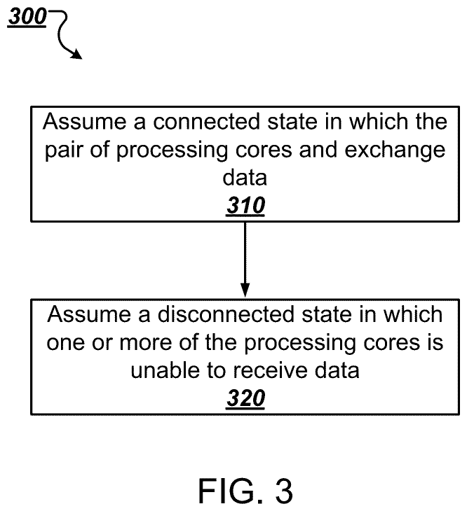

FIG. 3 is a flowchart of an example process 300 for managing an interface between a pair of processing cores. The example process 300 can be performed by a pair of processing cores which can be any two processing cores of a SOC having respective interface blocks that provide an interface including a data interface and a connect/disconnect interface between them. The example process 300 will be described as being performed by a pair of processing cores having respective interface blocks on an SOC of a device, programmed appropriately in accordance with this specification.

The pair of processing cores are generally capable of providing data processing capabilities and exchanging data thereamong. One or more of the pair of processing cores may be enabled or disabled by the device through the use of power controllers which regulate the power states of the processing cores.

The connect/disconnect interface between the pair of processing cores assumes a connected state of the interface in which the pair of processing cores and exchange data (310). Step 310 may thus be referred to as a connection handshake protocol. Connected state refers to the state of the interface during which the pair of processing cores can initiate and/or receive traffic through the data interface. An interface in the connected state can transport traffic at any time.

To transition into the connected state, one processing core generates a connection request to another processing core by way of sending a high idoreq signal through the connect/disconnect interface (that is received at the processing core as a high idireq signal), to which the other processing core may send back a reply acknowledgement (namely a high idoack signal) that is received at the processing core as a high idiack signal.

The connect/disconnect interface between the pair of processing cores assumes a disconnected state of the interface in which one or more of the processing cores is unable to receive data (320). Step 320 may thus be referred to as a disconnection handshake protocol. Disconnected state refers to the state of the interface during which processing cores must not initiate traffic through the data interface, since the other processing core may not be in an enabled state to receive such traffic. An interface in the disconnected state must not transmit traffic through the data interface.

To transition into the disconnected state, one processing core generates a disconnection request to another processing core by way of sending a low idoreq signal through the connect/disconnect interface (that is received at the processing core as a low idireq signal), to which the other processing core may send back a reply acknowledgement (namely a low idoack signal) that is received at the processing core as a low idiack signal.

Unlike a connection request from one processing core to another processing core which cannot be denied since interface connection is a planned event, a disconnection request could be denied by the other processing core. That is, following the receipt of the low idireq signal, the other processing core may send back a negative reply acknowledgement (namely a high idonak signal) that is received at the processing core as a high idinak signal. In such cases, the interface returns to the connected state.

In the disconnected state, there are two modes: 1) a disconnect-with-wakeup (DSCWK) mode during which new traffic causes the interface to assume a connected state; and 2) a disconnect-with-terminate (DSCGT) mode during which any traffic is terminated by one of the pair of processing cores, e.g., by the initiating processing core. That is, the disconnect-with-wakeup (DSCWK) mode allows for a connection request to be generated based on new traffic targeting the interface, while the disconnect-with-terminate (DSCGT) mode does not allow any traffic to cause the interface to exit the disconnected state and enter the connected state. To indicate what mode of disconnection is being requested, one processing core may additionally send an idomode signal through the connect/disconnect interface (that is received at the other processing core as idimode).

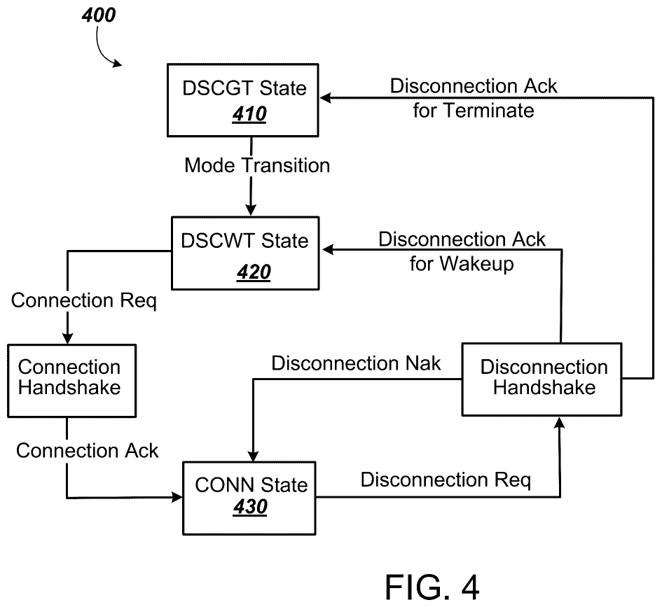

FIG. 4 is an illustration of an example state diagram 400 of different states of an interface between a pair of processing cores. The state diagram 400 describes the states associated with the interface as well as the possible state transitions between the states.

The interface may be in a disconnect-with-terminate (DSCGT) mode 410. A mode transition may occur from the DSCGT mode 410 to a disconnect-with-wakeup (DSCWK) mode 420 when both processing cores have power, clock and are out of reset. This indicates each processing core is ready to participate in the connection handshake.

While in the DSCWK mode 420, if either processing core detects that is has new traffic targeting the data interface between the pair of processing cores, and subsequently utilizes the connection handshake protocol as described above to generate a connection request to the other processing core which, when accepted by the other processing core, causes the interface to transition to the connected state 430. After this, the pair of processing cores may start to exchange data.

Later on, when power controller of either processing core detects that the interface has been inactive, e.g., has zero traffic, for a predetermined amount of time, the power controller can utilize the disconnection handshake protocol as described above to generate an opportunistic disconnection request. If the other processing core accepts the disconnection request, the interface transitions from the connected state 430 to the DSCWK state 420.

Alternatively, if the other processing core send a denial (a negative acknowledgement) of the disconnection request, the interface remains at the connected state 430.

Further alternatively, when either power controller detects that an interface has been inactive for a predetermined amount of time, or the power controller receives the command for a planned low power state, the power controller can utilize the disconnection handshake protocol as described above to generate a planned disconnection request. If the other processing core accepts the disconnection request, the interface transitions from the connected state 430 to the DSCGT state 410.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program which may also be referred to or described as a program, software, a software application, an app, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

As used in this specification, an “engine,” or “software engine,” refers to a hardware-implemented or software implemented input/output system that provides an output that is different from the input. An engine can be implemented in dedicated digital circuitry or as computer-readable instructions to be executed by a computing device. Each engine can be implemented within any appropriate type of computing device, e.g., servers, mobile phones, tablet computers, notebook computers, music players, e-book readers, laptop or desktop computers, PDAs, smart phones, or other stationary or portable devices, that includes one or more processing modules and computer-readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a host device having a display device, e.g., a CRT (cathode ray tube) or LCD (liquid crystal display) monitor, for displaying information to the user and a keyboard and pointing device, e.g., a mouse, trackball, or a presence sensitive display or other surface by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain some cases, multitasking and parallel processing may be advantageous.

What is claimed is:

1. A device comprising:
a pair of processing cores that are configured to exchange data, wherein the device is configured to enable or disable one or more of the pair of processing cores; and
and logic circuitry implementing a connect/disconnect interface between the pair of processing cores, wherein the connect/disconnect interface between the pair of processing cores is configured to:
assume a connected state in which the pair of processing cores exchange data; and
a disconnected state in which one or more of the processing cores is unable to receive data.

2. The device of claim 1, wherein the pair of processing cores sharing the connect/disconnect interface are controlled by respective power controllers.

3. The device of claim 1, wherein when in the disconnected state, the connect/disconnect interface can assume a disconnect-with-wakeup mode during which new traffic causes the connect/disconnect interface to assume a connected state.

4. The device of claim 1, wherein when in the disconnected state, the connect/disconnect interface can assume a disconnect-with-terminate mode during which any traffic is terminated by one of the pair of processing cores.

5. The device of claim 1, wherein each processing core is further configured to transmit output signals to another processing device comprising: i) a request to connect, ii) a request to disconnect, and iii) a denial of a disconnection request.

6. The device of claim 5, wherein each processing core is further configured to receive input signals from the other processing device comprising: i) a request to connect, ii) a request to disconnect, and iii) a denial of the disconnection request.

7. The device of claim 6, wherein the output signals and the input signals are implemented using six separate wires between the processing cores.

8. A method performed by a device comprising a pair of processing cores that are configured to exchange data, and wherein the device is configured to enable or disable one or more of the pair of processing cores, and wherein the device comprises logic circuitry implementing a connect/disconnect interface between the pair of processing cores, wherein the method comprises:
configuring the connect/disconnect interface between the pair of processing cores to assume a connected state in which the pair of processing cores exchange data, and
configuring the connect/disconnect interface between the pair of processing cores to assume a disconnected state in which one or more of the processing cores is unable to receive data.

9. The method of claim 8, wherein the pair of processing cores sharing the connect/disconnect interface are peer processing cores that are both controlled by a power manager.

10. The method of claim 8, wherein when in the disconnected state, the connect/disconnect interface can assume a disconnect-with-wakeup mode during which new traffic causes the connect/disconnect interface to assume a connected state.

11. The method of claim 8, wherein when in the disconnected state, the connect/disconnect interface can assume a disconnect-with-terminate mode during which any traffic is terminated by one of the pair of processing cores.

12. The method of claim 8, wherein each processing core is further configured to transmit output signals to the other processing device comprising: i) a request to connect, ii) a request to disconnect, and iii) a denial of a disconnection request.

13. The method of claim 12, wherein each processing core is further configured to receive input signals from the other processing device comprising: i) a request to connect, ii) a request to disconnect, and iii) a denial of a disconnection request.

14. The method of claim 13, wherein the output signals and the input signals are implemented using six separate wires between the processing cores.

15. A non-transitory, computer-readable medium storing instructions that, when accessed by a pair of processing cores that are configured to exchange data, cause the pair of processing cores to:
configure a connect/disconnect interface between the pair of processing cores to assume a connected state in which the pair of processing cores exchange data, and
configure the connect/disconnect interface between the pair of processing cores to assume a disconnected state in which one or more of the processing cores is unable to receive data.

16. The non-transitory, computer-readable medium of claim 15, wherein the pair of processing cores sharing the connect/disconnect interface are peer processing cores that are both controlled by a power manager.

17. The non-transitory, computer-readable medium of claim 15, wherein when in the disconnected state, the connect/disconnect interface can assume a disconnect-with-wakeup mode during which new traffic causes the connect/disconnect interface to assume a connected state.

18. The non-transitory, computer-readable medium of claim 15, wherein when in the disconnected state, the interface can assume a disconnect-with-terminate mode during which any traffic is terminated by one of the pair of processing cores.

19. The non-transitory, computer-readable medium of claim 15, wherein each processing core is further configured to transmit output signals to the other processing device comprising: i) a request to connect, ii) a request to disconnect, and iii) a denial of a disconnection request.

20. The non-transitory, computer-readable medium of claim 19, wherein each processing core is further configured to receive input signals from the other processing device comprising: i) a request to connect, ii) a request to disconnect, and iii) a denial of a disconnection request.
